(19) United States
(12) Patent Application Publication
(10) Pub. No.: US 2014/0314942 A1
(43) Pub. Date: Oct. 23, 2014

(54) METHOD OF TRANSFORMING A MEAL

(71) Applicants: Neile K. Edens, Columbus, OH (US); Keith A. Garleb, Pickerington, OH (US); Pamela A. Anderson, Washington Court House, OH (US)

(72) Inventors: Neile K. Edens, Columbus, OH (US); Keith A. Garleb, Pickerington, OH (US); Pamela A. Anderson, Washington Court House, OH (US)

(73) Assignee: ABBOTT LABORATORIES, ABBOTT PARK, IL (US)

(21) Appl. No.: 14/238,804

(22) PCT Filed: Aug. 16, 2011
(86) PCT No.: PCT/US2011/047885

§ 371 Date: May 28, 2014

(51) Int. Cl. A23L 1/29

(52) U.S. Cl. CPC A23L 1/293
USPC 426/648

(57) ABSTRACT

Disclosed are methods of transforming a meal to improve the suitability of the meal for an individual with specific dietary needs that may be due to a medical condition. The methods include assessing the meal relative to the individual's dietary needs and administering a composition to the meal that tailors the meal to the dietary needs of the individual. The composition comprises a nutrient for fortifying the meal and an anti-nutrient for reducing the absorption of undesirable components of the meal.

### TECHNICAL FIELD

The present disclosure relates to methods of transforming an ordinary meal into a meal more suitable for an individual with specific dietary needs that may be due to a medical condition. The transforming is done by assessing the specific nutritional needs of the person who is to consume the meal and administering to the meal a composition comprising a nutrient for fortifying the meal and an anti-nutrient for reducing the absorption of undesirable components.

### BACKGROUND OF THE DISCLOSURE

Ordinary meals, that may be prepared in the home or purchased at restaurants, may not always be particularly suitable for the individual consuming the meal, especially when the individual has specific dietary needs that may be due to a medical condition such as diabetes or impaired glucose tolerance, high cholesterol, a cardiovascular disease, chronic kidney disease, etc. For individuals with impaired glucose tolerance or diabetes, for example, many such meals may be excessively rich in high-glycemic carbohydrates and deficient in certain micronutrients and fiber. It is known that 60 to 90% of people with diabetes do not consume adequate amounts of vitamin C and 80 to 90% do not consume adequate amounts of vitamin D, calcium, and/or fiber.

Despite that fact that many individuals who have specific dietary needs due to a medical condition understand that they should carefully monitor their food intake from a nutritional standpoint, many individuals simply do not take the time nor make the effort to carefully control and monitor their food intake to properly manage their medical condition in a healthy manner. For example, individuals with diabetes are generally advised to restrict caloric intake, restrict carbohydrate intake, increase exercise, and carefully administer insulin or oral antiglycemic drugs. Although diabetic individuals routinely receive this advice to improve their health, a minority actually follow through on the advice and achieve adequate glycemic control.

As such, there is a need for methods of transforming an ordinary meal to improve the suitability of the meal from a nutritional standpoint for an individual with specific dietary needs. It would be particularly beneficial if the method allowed an individual to assess a meal relative to the individual with specific dietary needs and administer a composition including nutrients and anti-nutrients specifically chosen to transform the nutritional profile of the ordinary meal in a way that rectifies the shortcomings of the meal and improves the suitability of the meal for the individual with specific dietary needs.

### SUMMARY OF THE DISCLOSURE

One embodiment is directed to a method of transforming a meal to improve the suitability of the meal for an individual with specific dietary needs due to a medical condition. The method comprises assessing the meal relative to the individual with specific dietary needs and administering to the meal a composition that tailors the meal to the dietary needs of the individual. The composition comprises a nutrient and an anti-nutrient.

Another embodiment is directed to a method of transforming a meal to improve the suitability of the meal for an individual afflicted with impaired glucose tolerance or diabetes. The method comprises assessing the meal relative to the suitability of the meal for the individual with impaired glucose tolerance or diabetes and administering to the meal a composition that tailors the meal to the dietary needs of the individual. The nutritional composition comprises a nutrient and an anti-nutrient.

Another embodiment is directed to a method of transforming a meal to improve the suitability of the meal for an individual afflicted with a cardiovascular or circulatory disease or condition. The method comprises assessing the meal relative to the suitability of the meal for the individual with a cardiovascular or circulatory disease or condition and administering to the meal a composition that tailors the meal to the dietary needs of the individual. The nutritional composition comprises a nutrient and an anti-nutrient.

A therapeutic meal accompaniment composition may be administered to ordinary meals to transform and fortify the meals relative to the specific dietary needs of an individual. The composition administered to the meal comprises a nutrient and an anti-nutrient. The nutrient acts to fortify the meal by adding at least one nutrient to the meal that is otherwise deficient or lacking altogether, while the anti-nutrient improves the meal by preventing the absorption of undesirable components of the meal by the individual consuming the meal. The meal accompaniment composition may be tailored to the needs of an individual with a specific medical condition such that the individual can consume normal food products in a more healthy way, thus improving overall health.

Surprisingly, a meal may be optimized for a given health condition with a combination of a nutrient and an anti-nutrient ingredient specifically chosen to adjust the nutritional content of an ordinary meal in a way that rectifies the shortcomings of the meal and improves the nutritional appropriateness of the meal for an individual with a specific health condition. For example, as ordinary meals may be rich in high-glycemic carbohydrates, these meals are not generally suitable for individuals afflicted with impaired glucose tolerance or diabetes. By assessing these high-glycemic carbohydrate-containing meals and administering to these meals a composition including, for example, an anti-nutrient that is an inhibitor of carbohydrate digestion and/or absorption, spikes in blood glucose concentration may be attenuated. This allows for the individual to consume ordinary meals without the negative unhealthy side effects or requiring the individual to adjust his or her medication to compensate for the unwanted nutritional components.

Accordingly, the methods and compositions of the present disclosure may offer therapeutic alternatives to restrictive meals for individuals having specific dietary needs that may be due to medical conditions.

### BRIEF DESCRIPTION OF THE DRAWINGS

FIG. 1 is a graph depicting the effect of a nutritional composition including Salacia oblonga extract D and nutrients, including induced viscosity fiber, vitamin C, vitamin D, and chromium picolinate, administered to an ordinary meal on glycemic response to a meal as analyzed in Example 2.

FIG. 2 is a graph depicting the effect of a nutritional composition including Salacia oblonga extract D and nutrients, including induced viscosity fiber, vitamin C, vitamin D, and chromium picolinate, administered to an ordinary meal on insulinemic response to a meal as analyzed in Example 2.

FIG. 3 is a graph depicting the effect of nutritional compositions including Salacia oblonga extract D, Barliv and additional nutrients administered with a standard meal on change in plasma glucose concentration from baseline as analyzed in Example 3.

FIG. 4 is a chart depicting the effect of nutritional compositions including Salacia oblonga extract D, Barliv and additional nutrients administered with a standard meal on integrated area under the glucose curve above baseline as analyzed in Example 3.

### DETAILED DESCRIPTION OF THE DISCLOSURE

The methods disclosed herein are directed to methods of transforming an ordinary meal to tailor, fortify and improve the suitability of the meal for an individual with specific dietary needs, which may be due to a medical condition. The methods utilize compositions comprising a nutrient and an anti-nutrient chosen to adjust the nutritional profile of the ordinary meal to improve the nutritional suitability of the meal for the individual. The essential or optional elements or features of the various embodiments are described in detail hereinafter.

The term “nutrient” as used herein, unless otherwise specified, refers to a substance that provides energy or building material to the body.

The term “anti-nutrient” as used herein, unless otherwise specified, refers to a component that has an effect on body processes, but does not necessarily provide energy or building material. Anti-nutrient ingredients may catalyze or inhibit enzymatic and chemical processes within the body, including digestion and absorption.

The term “transforming a meal to improve the suitability of the meal” as used herein refers to an ordinary meal that has been improved relative to a specific medical condition of an individual; that is, a meal that is healthier for (i.e., has been fortified to have an improved nutrient profile), or more easily tolerated by, an individual having a specific medial condition.

The term “nutrient profile” as used herein refers to the nutritional value provided by the components in a meal. The nutrient profile can be adjusted by inhibiting or slowing the digestion and/or absorption of unwanted nutritive components, and/or providing an improved bioavailability of desired nutritive components.

The term “inhibitor of carbohydrate digestion and/or absorption” as used herein refers to a component capable of inhibiting and/or slowing carbohydrate digestion and/or absorption in the body. The inhibitor may prevent the break down and/or uptake of carbohydrates, and in particular, high-glycemic carbohydrates, by the digestive system of the individual.

The term “inhibitor of cholesterol absorption” as used herein refers to a component capable of reducing the absorption of cholesterol by an individual's digestive system (i.e., small intestine) into the bloodstream.

The term “ordinary meal” as used herein refers to at least a single serving meal in solid or liquid form typically consumed by an individual. The ordinary meal refers to a meal without the addition of a composition to modify the nutritive content of the meal and/or the digestion or absorption of nutritive components therein.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified.

All numerical ranges as used herein, whether or not expressly preceded by the term “about”, are intended and understood to be preceded by that term, unless otherwise specified.

The compositions and methods herein may also be free of any optional or other ingredient or feature described herein provided that the remaining composition still contains the requisite ingredients or features as described herein. In this context, the term “free” means the selected composition or method contains or is directed to less than a functional amount of the ingredient or feature, typically less than 0.1% by weight, and also including zero percent by weight, of such ingredient or feature.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

Any reference to singular characteristics or limitations of the present disclosure shall include the corresponding plural characteristic or limitation, and vice versa, unless otherwise specified or clearly implied to the contrary by the context in which the reference is made.

Any combination of method or process steps as used herein may be performed in any order, unless otherwise specifically or clearly implied to the contrary by the context in which the referenced combination is made.

The compositions and methods may comprise, consist of, or consist essentially of the elements and features of the disclosure described herein, as well as any additional or optional ingredients, components, or features described herein or otherwise useful in a nutritional application.

### Product Form

The compositions utilized in the methods of the present disclosure comprise at least one nutrient and at least one anti-nutrient as discussed herein. The compositions may be formulated in any known or otherwise suitable product form for oral administration. Oral product forms include any solid, liquid, or powder formulation suitable for use herein, provided that such a formulation allows for safe and effective oral delivery of the essential and other selected ingredients from the selected product form.

In one desirable embodiment, the composition including the nutrient and anti-nutrient ingredients is in powder form such that it can be shaken or sprinkled directly onto a meal or portion thereof prior to consumption of the meal to tailor and improve the meal relative to a specific condition, which may be a medical condition. In some embodiments, the powder form of the composition is introduced into a liquid beverage and the beverage consumed before, during, or after a meal to tailor and improve the meal relative to a specific condition.

### Nutrient Component

The methods of transforming a meal include the administration to the meal of a composition including at least one nutrient component that fortifies the meal when used in a targeted population. The nutrient component thus improves the nutritional quality and/or nutritional profile of the meal.

The types and amounts of nutrient components for use in the composition for transforming meals will vary depending on the other components of the composition, the components of the meal, and the specific dietary needs of the individual. The nutrient component can be included in the composition in an amount of from about 0.1% to about 99.9% (by weight) of the composition, including from about 10% to about 99.9%, including from about 25% to about 99.9%, including from about 50% to about 99.9%, including from about 78% to about 98% (by weight) of the composition.

Non-limiting examples of such nutrient components may include one or more minerals, non-limiting examples of which include phosphorus, sodium, chloride, magnesium, manganese, iron, copper, zinc, iodine, calcium, potassium, chromium (including chromium picolinate, chromium 454, and niacin-bound chromium), molybdenum, selenium, and combinations thereof.

Additional nutrients may also include one or more vitamins, non-limiting examples of which include carotenoids (e.g., beta-carotene, zeaxanthin, lutein, lycopene), biotin, choline, inositol, folic acid, pantothenic acid, vitamin A, thiamine (vitamin B1), riboflavin (vitamin B2), niacin (vitamin B3), pyridoxine (vitamin B6), cyanocobalamin (vitamin B12), ascorbic acid (vitamin C), vitamin D (including both vitamin D2 and vitamin D3), vitamin E, vitamin K, and various salts, esters or other derivatives thereof, and combinations thereof.

The nutrient may also be a fiber, such as a viscosity fiber or an induced viscosity fiber. Exemplary fibers that may be used as the nutrient include guar gum, gum arabic, sodium carboxymethyl cellulose, locust bean gum, tapioca starch, alginates, tapioca dextrins, citrus pectin, low and high methoxy pectin, carrageenan, cereal beta-glucans (e.g., oat beta-glucan and barley beta-glucan), prebiotics (e.g., fructooligosaccharides), psyllium, Fibersol, Fibersol-2, Nutriose, and combinations thereof. One suitable commercially available source of a barley beta-glucan for inclusion in the composition is Barliv, commercially available from Cargill (Panora, Iowa).

### Anti-Nutrient Component

The methods of transforming a meal include the administration to the meal of a composition including at least one anti-nutrient component that improves the meal when used in a targeted population. The anti-nutrient acts to modify and regulate the digestion and absorption of various components found in the meal. Non-limiting examples of anti-nutrient components for use in the compositions include inhibitors of carbohydrate digestion and/or absorption, inhibitors of cholesterol and/or saturated fat absorption, and inhibitors of electrolyte absorption. The anti-nutrient component thus improves the suitability of the meal for specific medical conditions requiring nutritional management.

The types and amounts of anti-nutrient components for use in the composition for transforming meals will vary depending on the other components of the composition, the components of the meal, and the specific dietary needs of the individual. The anti-nutrient component can be included in the composition in an amount of from about 0.1% to about 99.9% (by weight) of the composition, including from about 1% to about 50%, including from about 1% to about 25%, including from about 2% to about 20% (by weight) of the composition.

Inhibitors of Carbohydrate Digestion and/or Absorption

One example of an anti-nutrient component is an inhibitor of carbohydrate digestion and/or absorption. This anti-nutrient may be particularly useful in embodiments directed to transforming a meal to improve the suitability of the meal for an individual afflicted with impaired glucose tolerance or diabetes, or some other condition related to the digestion and absorption of carbohydrates.

The inhibitors of carbohydrate digestion and/or absorption inhibit, delay, and/or slow carbohydrate digestion and/or absorption, and in particular high-glycemic carbohydrates, thereby reducing the glycemic and insulinemic responses to a meal. Particularly suitable carbohydrate digestion inhibitors include alpha-glucosidase or amylase inhibitors or sources thereof that can be administered to the meal in an amount effective to inhibit/delay/slow the digestion of carbohydrates, including starch and table sugar. Alpha-glucosidase and amylase inhibitors are molecules that act as competitive inhibitors of enzymes needed to digest carbohydrates, specifically alpha-glucosidase enzymes in the brush border of the small intestine or salivary and pancreatic amylase, respectively.

In one embodiment, the compositions include a Salacia oblonga extract, which contains the alpha-glucosidase inhibitors salacinol, kotalanol and mangiferin, which have been shown to inhibit the activity of intestinal alpha-glucosidases and mitigate blood glucose responses upon ingestion of food. Any source of the extract that is known or otherwise suitable for use in an oral product is also suitable for use herein, provided that such a source is also compatible with, or is otherwise rendered to be compatible with, the other selected ingredients in the composition. Suitable Salacia oblonga extracts for use in the compositions and methods of the present disclosure include both powdered and liquid forms of Salacia oblonga extracts. Specific examples of suitable Salacia oblonga extracts include Salacia oblonga Extract A and Salacia oblonga Extract D (both powdered forms), commercially available from Tanabe Seiyaku Company Limited (Osaka, Japan).

In another embodiment, the anti-nutrient in the composition for inhibiting carbohydrate digestion and/or absorption includes curcumin or curcuminoids, such as curcumin C3 complex (Sabinsa Corporation, Piscataway, N.J.).

Other suitable exemplary inhibitors of carbohydrate digestion and/or absorption or sources thereof include Morus alba extract, prune extracts (including prune extracts having a polyphenol content of at least about 25% by weight), green tea polyphenols, mixed berry extract, e.g., Vitaberry ((Futureceuticals, Momence, Ill.) comprised of dried powders of blueberry, cranberry, raspberry, strawberry, prune, cherry, bilberry, and grape), grape pomace extract, MegaNatural GSKE (Polyphenolics, Inc., Madera, Calif.), Madeglucyl, and the like and combinations thereof.

Inhibitors of Cholesterol and/or Saturated Fat Absorption

Another example of an anti-nutrient component is an inhibitor of cholesterol and/or saturated fat absorption. This anti-nutrient may be particularly useful in embodiments directed to transforming a meal to improve the suitability of the meal for an individual afflicted with a cardiovascular or circulatory disease or condition. Inhibitors of cholesterol and/or saturated fat absorption include a class of compounds that prevent the uptake of cholesterol and saturated fat from the small intestine into the circulatory system.

Exemplary inhibitors of cholesterol and/or saturated fat absorption include phytosterols, fermentable fibers and starches, and medicinal compounds such as ezetimibe. Exemplary phytosterols for use as the cholesterol absorption inhibitor in the compositions include β-sitosterol, ergosterol, stigmasterol, brassicasterol, ergosterol, and combinations thereof.

### Inhibitors of Electrolyte Absorption

Another example of an anti-nutrient component is an inhibitor of electrolyte absorption, such as calcium acetate or calcium carbonate. This anti-nutrient may be particularly useful in embodiments directed to transforming a meal to improve the suitability of the meal for an individual afflicted with chronic kidney disease. In such embodiments, it may be beneficial to administer to the meal a composition including an inhibitor of electrolyte absorption, such as calcium carbonate and/or calcium acetate, to prevent the absorption of unwanted electrolytes such that the burden on the kidneys is reduced. Depending on an individual's medical condition, unwanted electrolytes may include one or more of phosphorous, potassium, and sodium.

### Macronutrients

The compositions comprising the nutrient and anti-nutrient components may optionally additionally comprise one or more macronutrients including a fat source, a carbohydrate source, and a protein source, all in addition to the nutrient and anti-nutrient components discussed herein.

Many different sources and types of proteins, fats, and carbohydrates are known and can be used in the oral compositions described herein, provided that the selected macronutrients are safe and effective for oral administration and are compatible with the essential and other added ingredients.

Carbohydrates suitable for use in the compositions may be simple, complex, or variations or combinations thereof. Non-limiting examples of suitable carbohydrates include hydrolyzed or modified starch or cornstarch, maltodextrin, glucose polymers, sucrose, corn syrup, corn syrup solids, rice-derived carbohydrate, glucose, fructose, lactose, high fructose corn syrup, indigestible oligosaccharides (e.g., fructooligosaccharides), soluble or insoluble fiber, honey, sugar alcohols (e.g., maltitol, erythritol, sorbitol), and combinations thereof.

Proteins suitable for use in the compositions include hydrolyzed, partially hydrolyzed or non-hydrolyzed proteins or protein sources, and can be derived from any known or otherwise suitable source such as milk (e.g., casein, whey), animal (e.g., meat, fish), cereal (e.g., rice, corn), vegetable (e.g., soy), or combinations thereof.

Fats suitable for use in the compositions include coconut oil, fractionated coconut oil, soy oil, corn oil, olive oil, safflower oil, high oleic safflower oil, MCT oil (medium chain triglycerides), diacylglycerol oil, monoacylglycerols, phospholipids, sunflower oil, high oleic sunflower oil, palm and palm kernel oils, palm olein, canola oil, marine oils, cottonseed oils, docosahexaenoic (DHA) oils, arachidonic (ARA) oils, and combinations thereof.

The concentration or amount of fat, protein, and carbohydrate in the compositions may vary considerably depending upon the particular product form (e.g., solid, liquid, powder) and the various other formulations and targeted dietary needs. These macronutrients are most typically formulated within any of the caloric ranges (embodiments A-F) described in the following table (each numerical value is preceded by the term “about”).

| Macronutrient | Embodiment A | Embodiment B | Embodiment C |
|---|---|---|---|
| Carbohydrate | 0-98 | 2-96 | 10-75 |
| % Total Calories | | | |
| Protein | 0-98 | 2-96 | 5-70 |
| % Total Calories | | | |
| Fat | 0-98 | 2-96 | 20-85 |
| % Total Calories | | | |
| | Embodiment D | Embodiment E | Embodiment F |
| Carbohydrate | 30-50 | 25-50 | 25-50 |
| % Total Calories | | | |
| Protein | 15-35 | 10-30 | 5-30 |
| % Total Calories | | | |
| Fat | 35-55 | 1-20 | 2-20 |
| % Total Calories | | | |

The compositions may further include optional components including, for example, preservatives, antioxidants, buffers, pharmaceutical actives, sweeteners, prebiotics, probiotics, colorants, flavors, flavor enhancers, thickening agents and stabilizers, emulsifying agents, lubricants, and so forth.

### Manufacture

The nutrient and anti-nutrient-containing compositions for use in the methods of the present disclosure may be prepared by any known or otherwise effective manufacturing technique for preparing the selected product form. Many such techniques are known for any given product form such as liquids or powders and can easily be applied by one of ordinary skill in the art to the compositions described herein.

As a basic powdered particulate formulation, the compositions of the present disclosure may be prepared by dry blending or dry mixing the various components together. Alternatively, the particulate formulation may be prepared by conventional manufacturing techniques utilizing spray drying to produce the powder.

As a basic liquid formulation, the compositions may be prepared by conventional methods for preparing liquid nutritionals, or by dissolving the soluble nutrient and anti-nutrient components in water or a dilute acid solution to form a liquid.

The compositions of the present disclosure may, of course, be manufactured by other known or otherwise suitable techniques not specifically described herein without departing from the spirit and scope of the present disclosure. The present embodiments are, therefore, to be considered in all respects as illustrative and not restrictive and that all changes and equivalents also come within the description of the present disclosure.

### Packaging

The nutrient and anti-nutrient-containing compositions may be packaged in any commercially acceptable manner, including bulk packaging, multi-dose packaging, and single dose packaging. In one embodiment, the composition is a powder that is packaged in a single serving pouch, sachet, or other suitable container, such that the single serving package can be opened and the contents sprinkled onto food or into a beverage and the package discarded. The single serving packaging provides a discreet, convenient packaging form for consumer use.

### Methods of Use

The compositions as described herein are used as meal accompaniments for transforming and tailoring a meal to improve the suitability and nutritional value or profile of the meal for an individual with specific dietary needs, which may be due to a medical condition. Generally, the methods comprise first assessing the meal relative to the individual with specific dietary needs. This assessment reveals the shortcomings of the meal and determines what nutrient and anti-nutrient ingredients can be utilized to improve the meal. In one example, an individual afflicted with or at risk of impaired glucose tolerance or diabetes, may assess a meal as containing a large amount of high-glycemic carbohydrates, which are digested quickly by the individual, increasing blood glucose levels rapidly.

Another example may be assessing a meal for an individual afflicted with a cardiovascular or circulatory disease or condition. An ordinary meal may be assessed as including a high fat content with high levels of cholesterol. While cholesterol may be beneficial in that it is required to build and maintain membranes in the body, and further, functions in intracellular transport, cell signaling and nerve condition, elevated plasma cholesterol concentrations (i.e., hypercholesterolemia) are strongly associated with cardiovascular disease as these levels promote atheroma formation in the walls of arteries, which can cause inflammation of the arterial wall.

Assessment of the meal relative to the individual's specific dietary needs can be performed by the individual himself by considering the medical condition of the individual and the components of the meal; that is, the types of macronutrients and other components in the meal and the amounts of each type of component. Alternatively, a medical professional can assess various meals for individuals.

Once the assessment is complete and the shortcomings identified, a composition including the nutrient and anti-nutrient is administered to the meal to transform the nutrient profile and nutritional value of the meal relative to the specific dietary needs of the individual who will consume the meal. The “administration” of the composition to the meal may, for example, be by means of sprinkling or shaking the composition onto all or part of the meal, or may be by introducing the composition into a beverage that is consumed before, during, or after the meal.

The methods of transforming a meal as described herein may be useful for many individuals, including, for example, individuals afflicted with or otherwise at risk of developing conditions such as, for example, people with elevated risk of developing type 2 diabetes, such as those with obesity, family history of diabetes, large waist circumference, high waist-to-hip ratio, elevated fasting blood glucose concentration, impaired glucose tolerance, or any composite diabetes risk score, high PreDx score, or diabetes, especially type 2 diabetes; cardiovascular or circulatory disease or conditions (e.g., poor circulation, peripheral artery disease, impaired flow-mediated dilation, cardiomyopathy, arrhythmias, coronary heart disease, endocarditis, stroke, congestive heart failure, etc.); chronic kidney disease; arthritis; sarcopenia; cancer cachexia; and cognitive decline.

When the methods of transforming a meal are utilized by a person with impaired glucose tolerance and/or diabetes who seeks to blunt the glycemic response, in one embodiment the nutrient and anti-nutrient-containing composition will comprise a Salacia oblonga extract, a viscosity fiber including induced viscosity fiber, vitamin C, vitamin D, and chromium picolinate. In this embodiment, the induced viscosity fiber may comprise guar and maltodextrin and optionally a beta-glucan, such as barley beta-glucan.

When the methods of transforming a meal are utilized by a person with a cardiovascular disease who seeks to inhibit the absorption of cholesterol and/or saturated fat, in one embodiment the nutrient and anti-nutrient-containing composition will comprise a fermentable fiber or resistant starch in combination with antioxidants and phytosterols. In this embodiment, the composition may specifically include guar or Fibersol in combination with vitamin C, vitamin E and phytosterols.

### EXAMPLES

The following Examples illustrate specific embodiments and/or features of the compositions and methods of the present disclosure. The Examples are given solely for the purpose of illustration and are not to be construed as limitations, as many variations thereof are possible without departing from the spirit and scope of the disclosure.

### Example 1

In this Example, the ability of a composition comprising a nutrient and an anti-nutrient to improve the nutrient profile of an ordinary meal is analyzed.

The nutrient and anti-nutrient-containing composition is prepared by mixing together, in powder form, the following components: 240 mg Salacia oblonga extract D (Tanabe Seiyaku Company Limited Osaka, Japan); 750 mg induced viscosity fiber (500 mg guar and 250 mg maltodextrin); 60 mg vitamin C; 100 IU vitamin D; and 1.6 mg chromium picolinate.

The daily values (DV) of the various nutrient components provided by a standard meal, as well as the combined DV values of the composition and the standard meal, are shown in Table 1.

TABLE 1

| | | Standard Meal with |
|---|---|---|
| | Standard Meal (% DV) | Composition (% DV) |
| Vitamin C | 5 | 105 |
| Vitamin D | 0 | 25 |
| Chromium | 0 | 167 |
| Fiber | 18 | 21 |

By fortifying the meal with 105% of the daily value of vitamin C, the antioxidant defense of the individual is improved. Further, the composition provides the meal with 25% of the daily value of vitamin D and 167% of the daily value of chromium, deficiencies of which are implicated in insulin resistance. The fiber content of the meal is further increased by about 3% of the daily value for fiber, which may help control hunger, a common side effect for individuals with diabetes. As such, the nutrient profile of the meal is improved.

### Example 2

In this Example, the ability of a composition comprising a nutrient and an anti-nutrient to reduce/slow the absorption of carbohydrates from the gastrointestinal tract and improve the nutrient profile of a meal is analyzed.

Twenty Obese Zucker rats at the age of 9 weeks were assigned to two treatment groups of ten animals each. The effect of a meal transformation solution on blood glucose and plasma insulin was tested in a meal tolerance test using a rice ball feeding procedure. For this procedure, the rice was prepared by cooking 189.45 grams of rice with 405 mL of distilled water in a rice steamer basket. Four grams of rice containing 1.09 grams of carbohydrate are formed into a ball.

Rats were trained to consume rice balls by feeding the rats a small amount of rice every day for seven days, slowly increasing the amount of rice fed to reach a total of 4 grams.

On the day of the experiment, overnight-fasted rats were gavaged (10 mL/kg body weight) with control solution (water) or meal transformation solution containing: (1) Salacia oblonga extract D (2.5 mg/mL); (2) guar gum (5.0 mg/mL) plus maltodextrin (2.5 mg/mL) (“induced viscosity fiber; IVF”); (3) vitamin C (1.88 mg/mL); (4) vitamin D (0.015 mg/mL); and (5) chromium picolinate (0.0198 mg/mL). Both groups were given rice balls (4 grams containing 1.09 grams carbohydrate) to eat immediately after gavage.

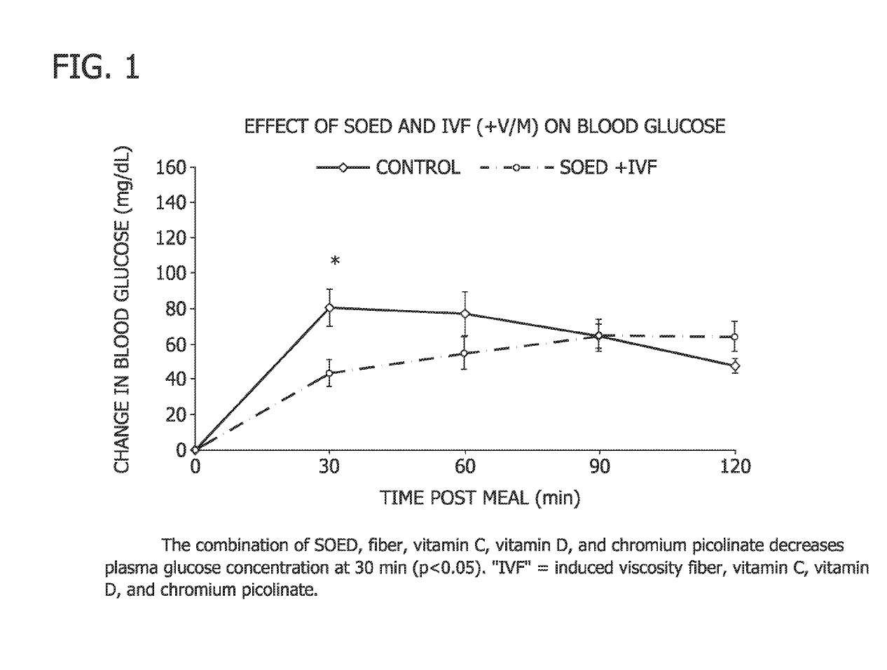

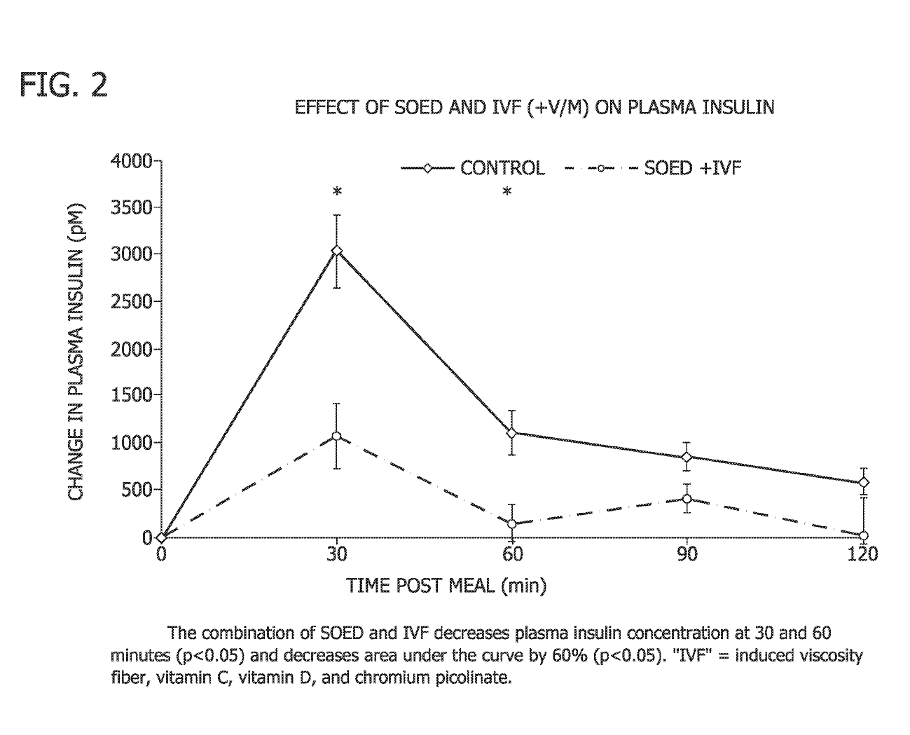

Blood samples from the rats were obtained from the tip of the tail before the gavage and at 0, 30, 60, 90, and 120 minutes post-meal, for glucose and insulin analysis. Glucose was determined directly using a Precision G glucose analyzer (Medisense, Bedford, Mass., USA). Plasma was isolated from the blood samples by centrifugation and the plasma insulin concentration was measured by enzyme immunoassay, using rat insulin as standard (ALPCO-Mercodia Ultra sensitive rat insulin ELISA). The results are shown in FIGS. 1 and 2.

As shown in FIGS. 1 and 2, by adding the composition to the meal, the plasma glucose concentration of the rats at 30 minutes post-meal consumption is reduced (p<0.05). Further, the overall post-prandial glycemic response to the meal by the rats, as measured by glucose area under the curve, is reduced by about 34%. The increment in plasma insulin concentration at 30, 60, and 90 minutes post meal consumption is also decreased, and the overall post-prandial insulinemic response, as measured by area under the insulin curve, is reduced by about 60% (p<0.05). By reducing the glycemic response to the meal, the meal is optimized for an individual afflicted with type 2 diabetes. By reducing the insulinemic response to the meal, the meal is optimized by reducing exposure of the individual to high levels of circulating insulin, which may exacerbate insulin resistance.

### Example 3

In this Example, the ability of various compositions comprising a nutrient and/or an anti-nutrient to attenuate postprandial glucose responses of subjects with type 2 diabetes was analyzed. The nutrient and/or anti-nutrient-containing compositions are prepared by mixing together, in powder form, the following components shown in the Table below.

| | | | | 180 mg SOE-D + | 120 mg SOE-D + |
|---|---|---|---|---|---|
| | | | | Barliv ™ + | Barliv ™ + |
| | | | 180 mg SOE-D + | Additional | Additional |
| Ingredient (g) | Control | 240 mg SOE-D | Barliv ™ | Nutrients | Nutrients |
| Maltodextrin | 1.0 | 1.0 | 1.0 | 1.0 | 1.0 |
| Salacia oblonga | — | 0.240 | 0.180 | 0.180 | 0.120 |
| extract D (SOE-D) | | | | | |
| Barliv ™ | — | — | 1.1 | 1.1 | 2.0 |
| Xanthan Gum | — | — | 0.1 | 0.1 | 0.1 |
| Nutriose | — | — | — | 6.0 | 5.0 |
| Fructo- | — | — | — | 0.52 | 0.68 |
| oligosaccharide | | | | | |
| Fructose | — | — | — | 1.0 | 1.0 |
| Tricalcium Phosphate | — | — | — | 0.10 | 0.10 |
| Total Net Weight | 1.0 | 1.24 | 2.38 | 10.0 | 10.0 |

Each composition was used to prepare individual treatment beverages by adding 180 mL of room temperature water to a bottle containing one serving of product. The lid was closed and the mixture was shaken to dissolve. The dissolved product was poured into an opaque cup to prepare to be served. Another 60 mL of room temperature water was added to rinse the bottle to dissolve any residues. This 60 mL was added to the opaque cup to make up a full serving of 240 mL. The product was served in the opaque cup with a lid and a straw. The product beverage was served within 15 minutes of preparation. The product was served together with the test meal. An individual treatment beverage and a standard meal having the characteristics shown in the Table below were administered to a person afflicted with type 2 diabetes within a 15 minute time period.

| | Serving | Energy | Fat | Protein | Carbohydrate | Fiber | Sugar | Vit C | | |
|---|---|---|---|---|---|---|---|---|---|---|
| | Size | (kcal) | (g) | (g) | (g) | (g) | (g) | DV⁴ | Vit D | Chromium |
| Jasmine Rice, | 199 g | 255.7 | 0.7 | 4.2 | 56 | 1.4 | 0 | 0 | NL⁵ | NL |
| 266 g cooked¹ | | | | | | | | | | |
| Glazed | 1 meal | 210 | 2 | 17 | 29 | 0 | 6 | 8% | NL | NL |
| Chicken² | (8.5 | | | | | | | | | |
| | ounces) | | | | | | | | | |
| Vegetable | 1 tsp (5 g) | 40 | 5 | 0 | 0 | 0 | 0 | 0 | NL | NL |
| Oil³ | | | | | | | | | | |
| Total | 462 g | 510.7 | 7.7 | 21.2 | 85.0 | 1.4 | 6 | 8% | — | — |

¹Trader Joe's ® Frozen Jasmine Rice, microwavable
²Lean Cuisine ® Roasted Chicken Tenderloins with mushrooms, rice pilaf and green beans, Microwavable entrée
³Vegetable oil to be added to the Lean Cuisine ® and Rice mixture and stirred before serving
⁴DV = Daily Value based on a 2,000 calorie diet
⁵NL = not listed on Nutrition Facts panel of product

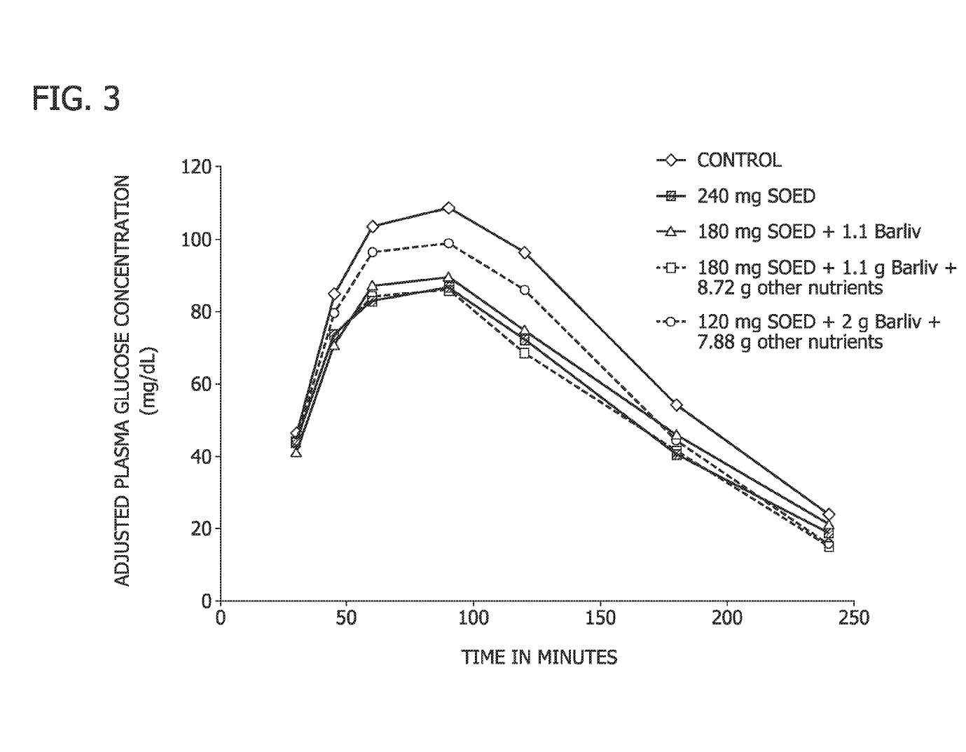

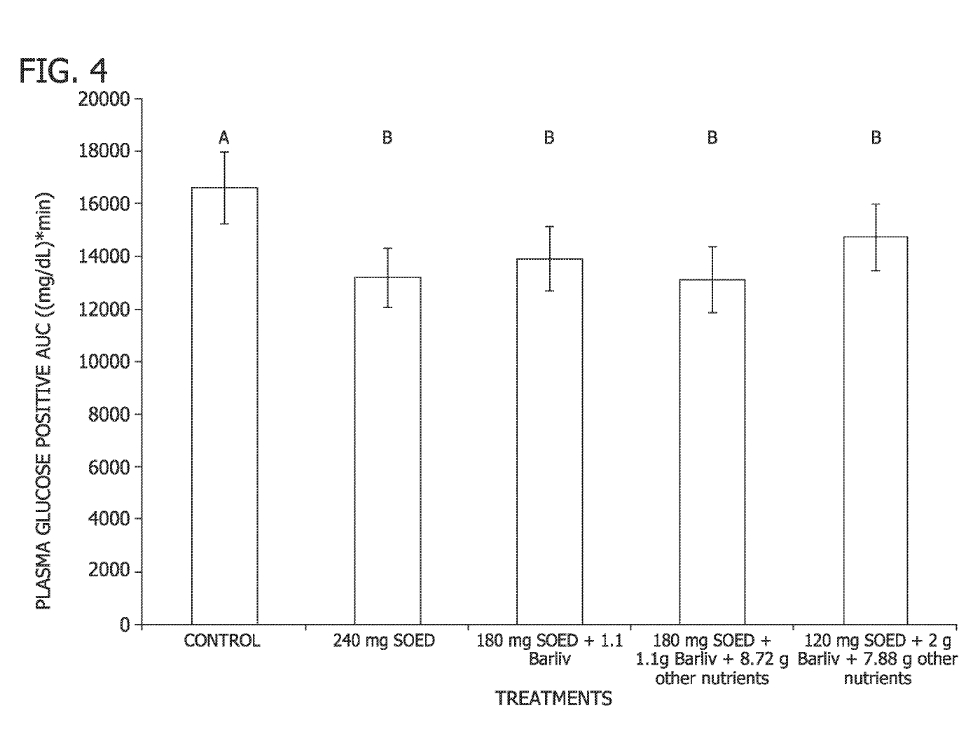

Blood samples were drawn before the meal (0 time baseline) and at 30, 60, 90, 120, and 240 minutes after the meal for the determination of adjusted (changed from baseline) glucose levels. The results are shown in FIGS. 3 and 4.

As shown in FIG. 3, by consuming a composition comprising a nutrient and/or an anti-nutrient with the meal, the mean plasma glucose concentration at 30, 60, 90, 120, and 240 minutes post-consumption is reduced. The largest reductions occur between 60 and 120 minutes post-consumption of treatment beverages containing at least 180 mg of Salacia oblonga extract D. As shown in FIG. 4, consumption of each composition significantly reduced the integrated positive area under the glucose curve (AUC). Thus, administering the composition with a standard meal improved the nutritional quality or profile of the meal by both providing additional fiber and by blunting the glycemic response of the meal.

What is claimed is:

1. A method of transforming a meal to improve the suitability of the meal for an individual with specific dietary needs due to a medical condition, the method comprising assessing the meal relative to the individual with specific dietary needs and administering to the meal a composition that tailors the meal to the dietary needs of the individual, the composition comprising a nutrient and an anti-nutrient.

2. The method of claim 1 wherein the medical condition is selected from the group consisting of impaired glucose tolerance or diabetes, cardiovascular or circulatory disease or disorder, chronic kidney disease, sarcopenia, cancer cachexia, and cognitive decline.

3. The method of claim 1 wherein the anti-nutrient is an inhibitor of carbohydrate digestion and/or absorption.

4. The method of claim 1 wherein the nutrient is selected from the group consisting of a vitamin, a mineral, a fiber, and combinations thereof.

5. The method of claim 3 wherein the inhibitor of carbohydrate digestion and/or absorption is an alpha-glucosidase or amylase inhibitor.

6. The method of claim 3 wherein the composition comprises from about 0.1% to about 99.9% by weight inhibitor of carbohydrate digestion and/or absorption.

7. A method of transforming a meal to improve the suitability of the meal for an individual afflicted with impaired glucose tolerance or diabetes, the method comprising assessing the meal relative to the suitability of the meal for the individual with impaired glucose tolerance or diabetes and administering to the meal a composition that tailors the meal to the dietary needs of the individual, the composition comprising a nutrient and an anti-nutrient.

8. The method of claim 7 wherein the anti-nutrient is an inhibitor of carbohydrate digestion and/or absorption.

9. The method of claim 7 wherein the nutrient is selected from the group consisting of a vitamin, a mineral, a fiber, and combinations thereof.

10. The method of claim 9 wherein the nutrient is selected from the group consisting of calcium, vitamin C, vitamin D, and combinations thereof.

11. The method of claim 7 wherein the nutrient comprises bioavailable chromium.

12. The method of claim 11 wherein the bioavailable chromium is chromium picolinate.

13. The method of claim 9 wherein the fiber is selected from prebiotics, gums, beta-glucans, fermentable fibers, and resistant starches.

14. The method of claim 8 wherein the inhibitor of carbohydrate digestion and/or absorption is an alpha-glucosidase or amylase inhibitor.

15. A method of transforming a meal to improve the suitability of the meal for an individual afflicted with a cardiovascular or circulatory disease or condition, the method comprising assessing the meal relative to the suitability of the meal for the individual with a cardiovascular or circulatory disease or condition and administering to the meal a composition that tailors the meal to the dietary needs of the individual, the composition comprising a nutrient and an anti-nutrient
